(19) United States
(12) Patent Application Publication
(10) Pub. No.: US 2008/0189978 A1
(43) Pub. Date: Aug. 14, 2008

(54) Clothes Drying and Dewrinkling Cabinet

(76) Inventors: Aitor Aizpuru Borda, San Sebastian (ES); Mikel Markotegi Ijurko, Etxarri Aranaz (ES); Kepa Bengoa Armendariz, Aretxabaleta (ES)

Correspondence Address: BERENBAUM, WEINSHIENK & EASON, P.C, 370 17TH STREET, SUITE 4800, DENVER, CO, 80202, US

(21) Appl. No.: 11/886,405

(22) PCT Filed: Mar. 13, 2006
(86) PCT No.: PCT/ES2006/070030

§ 371 Date: Sep. 13, 2007

(30) Foreign Application Priority Data
Mar. 23, 2005 (ES) P 200500675

(51) Int. Cl. F26B 21/10; A47B 96/00; F26B 19/00; F26B 21/08

(52) U.S. Cl. 34/549; 312/236; 34/557; 34/572

(57) ABSTRACT

Clothes drying and dewrinkling cabinet that comprises a closed and static enclosure (2) that defines an inner space (3) for housing clothes, an air flow generator (4) for circulating air through said inner space (3), heating means (5) for heating said air flow, and control means for controlling a drying and dewrinkling process acting on the air flow generator (4) and the heating means (41). The cabinet of the invention also comprises a sensor (7) that measures the temperature (T) and the humidity (H) of the air flow after said air flow has passed through the inner space (3), so that the control means perform the drying and dewrinkling process as a function of said temperature (T) and said humidity (H).

### TECHNICAL FIELD

The present invention relates to clothes drying cabinets and more specifically to clothes drying and dewrinkling cabinets.

### PRIOR ART

Clothes drying cabinets that comprise a closed and static enclosure that defines an inner space for housing clothes are known, the drying process being performed by means of a flow of hot air that is circulated through said inner space.

There are two types of clothes drying cabinets: exhaust cabinets and condensation cabinets. In exhaust cabinets the air flow that is circulated through the clothes disposed in the inner space is expelled to the exterior of the cabinet. In contrast, in condensation cabinets after said air flow has passed through the inner space it is passed through condensation means and is recirculated towards the inner space, the water contained in said air flow being condensed by means of said condensation means.

ES 2178538 B1 discloses a clothes drying and dewrinkling cabinet of the exhaust type. Said cabinet comprises a main enclosure that defines an inner space for housing clothes, means for supplying air inside the inner space, means for supplying steam inside the inner space, control means for controlling said means and at least one airing duct.

EP 0915199 B1 discloses a drying and dewrinkling cabinet of the condensation type, applied mainly to clothes. The cabinet described comprises a condenser in which a cross flow is circulated to cool the air flow that passes through the inner space in which the clothes are disposed.

### DISCLOSURE OF THE INVENTION

It is the object of the invention to provide a clothes drying and dewrinkling cabinet in which a process of drying and dewrinkling can be controlled simply and effectively.

The cabinet of the invention comprises a closed and static enclosure that defines an inner space for housing clothes, an air flow generator for circulating air through said inner space, heating means for heating said air flow, and control means for controlling a drying and dewrinkling process acting on the air flow generator and the heating means.

The cabinet also comprises a sensor that measures the temperature and the humidity of the air flow after said air flow passes through the inner space. The control means perform the drying and dewrinkling process as a function of said temperature and said humidity.

If the cabinet of the invention comprises condensation means, the control means control the drying and dewrinkling process based on the measured temperature, the dew temperature (obtained from the temperature and the humidity) and the maximum thermal jump of said condensation means. The maximum thermal jump of the condensation means is the difference in temperature of the air flow between the intake and the outlet of the condensation means when condensation does not occur.

If the cabinet of the invention is of the exhaust type, the control means control the dewrinkling process by means of the specific humidity obtained from the measured temperature and humidity. In condensation-type cabinets control can also be performed by using the specific humidity, or said control may even be complemented by the one that has been performed based on the measured temperature, the dew temperature and the maximum thermal jump of the condensation means.

In the cabinet of the invention only two variables are used when performing the control of the clothes drying and dewrinkling process: the temperature of the air flow that passes through the inner space of the cabinet, and the humidity of said flow. This means that the use of a single temperature and humidity sensor is sufficient to control the process.

These and other advantages and characteristics of the invention will be made evident in the light of the drawings and the detailed description thereof.

### DESCRIPTION OF THE DRAWINGS

FIG. 1 shows a cross-sectional profile view of an embodiment of the cabinet of the invention.

FIG. 2 is a diagram that shows the maximum thermal jump in the condensation means of the cabinet of FIG. 1, in other words, the thermal jump when there is no condensation.

FIG. 3 is a diagram that shows the maximum thermal jump in the condensation means of the cabinet of FIG. 1 when there is condensation.

FIG. 4 is a diagram that shows the variation in the specific humidity during a drying and dewrinkling process.

### DETAILED DISCLOSURE OF THE INVENTION

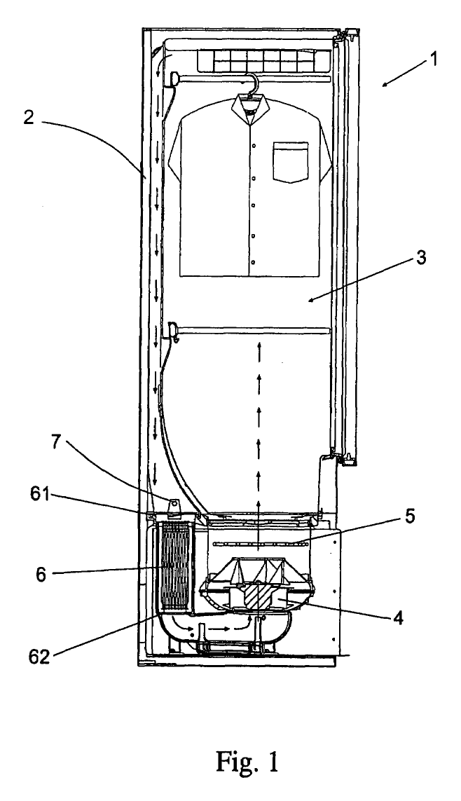

According to the embodiment of the invention shown in FIG. 1, the clothes drying and dewrinkling cabinet of the invention comprises a closed and static enclosure 2 that defines an inner space 3 for housing clothes, an air flow generator 4 for circulating air through said inner space 3, heating means 5 for heating said flow of air, and control means for controlling a drying and dewrinkling process acting on the air flow generator 4 and the heating means 41.

The cabinet of the invention also comprises a sensor 7 that measures the temperature T and the humidity H of the air flow after said air flow passes through the inner space 3. The control means perform the drying and dewrinkling process as a function of said temperature T and said humidity H.

In the embodiment shown in FIG. 1, the cabinet is of the condensation type. It thus comprises condensation means 6 for condensing the water in the air that circulates through the inner space 3. The air flow reaches the intake 61 of the condensation means 6 after said air flow passes through said inner space 3. In this embodiment, the sensor 7 is disposed at the intake 61 of the condensation means 6.

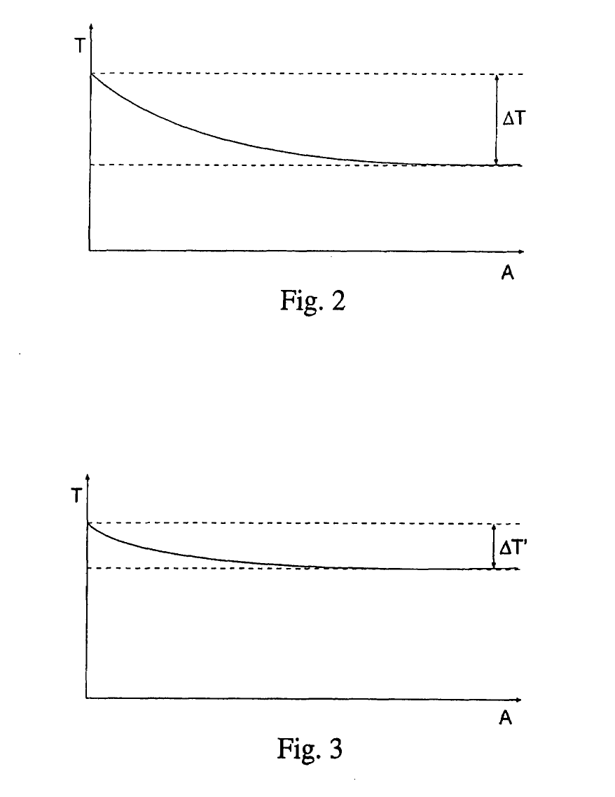

The control means control the drying and dewrinkling process depending on the difference between the measured temperature T and the dew temperature Tr (obtained from said temperature T and the measured humidity H), a link thereby being established between said difference and the maximum thermal jump ΔT of the condensation means 6. The maximum thermal jump ΔT is the difference in temperature of the air flow between the intake 61 and the outlet 62 of the condensation means when condensation does not occur. This is the situation shown in FIG. 2, which shows the variation in the temperature of the air flow that passes through the condenser depending on the heat exchange area A. FIG. 3 shows a situation in which there is condensation and as a result of which the humidity in the inner space 3 is extracted, in which case there is a thermal jump ΔT′ smaller than ΔT.

The control means compare the difference between the temperature T and the dew temperature Tr with the maximum thermal jump ΔT multiplied by a coefficient k, continuing with the drying and dewrinkling process as long as the condition that said difference is smaller than the maximum thermal jump ΔT multiplied by the coefficient k is fulfilled, in other words, the drying and dewrinkling process ends when the following is no longer fulfilled:

T−Tr<k·ΔT (1)

A larger or smaller degree of drying is obtained depending on the selected value of the coefficient k. A value of k=1 would mean that the drying and dewrinkling process would finish when the condensation means 6 stop condensing. With a value of k>1, the drying and dewrinkling process would finish before said situation arises, a smaller degree of drying being obtained. A value of k<1 would mean, nevertheless, that the air flow would continue to circulate through the clothes even when there is no condensation, a larger degree of drying being obtained. The value of the coefficients k may be obtained and adjusted empirically.

The equation (1) is not only applied to complete the drying and dewrinkling process but also to abort said process if there are no clothes in the inner space 3. Thus, at the beginning of the drying and dewrinkling process if it is observed that the condensation means 6 do not condense, this means that the user has not introduced wet clothing. Instead of directly comparing the difference T−Tr with the maximum thermal jump ΔT, in this case it is also compared with said maximum thermal jump multiplied by a coefficient K. In this way, the process of detecting the absence of clothes depending on the characteristics of the condensation means 6 and the circumstances of the environment is optimised, a value equal to a predetermined constant that is obtained empirically being applied to the coefficient k.

In addition, the control means deduce the water load in the inner space 3 depending on the variation in the temperature T measured in an initial phase of the drying and dewrinkling process. The greater the water load in the inner space 3, the slower the increase in the temperature over time, in other words, the smaller the slope of the variation of the temperature over time. Routine checks may be made to establish a correlation between the variation of the temperature and the water load in the inner space 3.

The drying and dewrinkling process essentially comprises a first phase of dewrinkling and a second phase of drying. The control means determine the dewrinkling temperature Td for said dewrinkling phase depending on the water load in the inner space 3 in the initial phase of the drying and dewrinkling process. The greater the water load in the inner space 3, the greater the dewrinkling temperature Td corresponding to it.

A large water load does not necessarily mean that there is a large amount of clothes to be dewrinkled and dried. This also depends on the type of clothes. Thus, in the event that there are delicate clothes to be dewrinkled and dried, given that delicates accumulate little water, the dewrinkling temperature Td that is used will be sufficiently low so as not to damage them.

The cabinet of the invention may be an exhaust-type cabinet as opposed to a condensation-type cabinet. In such cases the control means obtain the specific humidity W, based on the temperature T and the humidity H, and control the drying and dewrinkling process depending on said specific humidity W.

In embodiments of the invention in which the specific humidity W is used, the control means determine the specific humidity in the period of constant intensity W_{PIC}, and continue with the drying and dewrinkling process for as long as the condition that the specific humidity W obtained minus the initial specific humidity W₀ is greater than a certain percentage p of the specific humidity in the period of constant intensity W_{PIC} minus the initial specific humidity W₀ is fulfilled, in other words, the drying and dewrinkling process ends when the following is no longer fulfilled:

W−W₀>p·(W_{PIC}−W₀) (2)

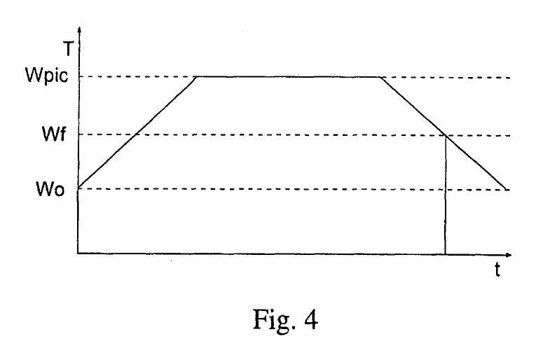

The variation of the specific humidity W during the drying and dewrinkling process is similar to that shown in FIG. 4. There is a first phase in which said specific humidity increases, followed by a second phase in which the specific humidity W has an approximately constant value. Said value of the specific humidity W is that which is termed specific humidity in the period of constant intensity W_{PIC}. Then, in a third phase, the specific humidity W starts to decrease.

Depending on the required degree of drying a certain percentage p is selected, different percentages p being obtained. The drying and dewrinkling process ends when a specific final humidity W_{f} is reached and for which the following is fulfilled:

W_{f}−W₀=p·(W_{PIC}−W₀) (3)

### That is to say:

W_{f}=p·(W_{PIC}−W₀)+W₀ (4)

The control means also deduce that there is an absence of clothes in the inner space 3 depending on the specific humidity W. Indeed, if the average specific humidity W does not vary at the beginning of the drying and dewrinkling process, this means that there is no humidity in the inner space 3 and that there are, therefore, no clothes to dewrinkle and dry in said inner space 3.

In addition, the control means deduce the water load in the inner space 3 depending on the variation in the average temperature T measured in an initial phase of the drying and dewrinkling process, just as was the case in the condensation cabinet.

Control by virtue of the specific humidity may also be employed in condensation cabinets as a complementary control to be performed through the dew temperature Tr and the maximum thermal jump ΔT.

1. Clothes drying and dewrinkling cabinet comprising
a closed and static enclosure that defines an inner space for housing clothes;
an air flow generator for circulating air through said inner space;
heating means for heating said air flow;
control means for controlling a drying and dewrinkling process acting on the air flow generator and the heating means; and
a sensor that measures the temperature (T) and the humidity (H) of the air flow after said air flow has passed through the inner space, so that the control means perform the drying and dewrinkling process as a function of said temperature (T) and said humidity (H).

2. Cabinet according to the preceding claim, wherein it comprises condensation means for condensing the water in the air that circulates through the inner space, the air flow reaching the intake of the condensation means after said air flow passes through said inner space, the control means controlling the drying and dewrinkling process depending on the difference between the measured temperature (T) and the dew temperature (Tr), obtained from said measured temperature (T) and humidity (H), a link thereby being established between said difference and the maximum thermal jump (ΔT) of the condensation means.

3. Cabinet according to the preceding claim, wherein the sensor is disposed at the intake of the condensation means.

4. Cabinet according to claim 2, wherein the control means compare the difference between the temperature (T) and the dew temperature (Tr) with the maximum thermal jump (ΔT) multiplied by a coefficient (k), continuing with the drying and dewrinkling process as long as the condition that said difference is smaller than the maximum thermal jump (ΔT) multiplied by the coefficient (k) is fulfilled.

5. Cabinet according to the preceding claim, wherein the control means select the value of the coefficient (k) depending on the required degree of drying.

6. Cabinet according to claim 4, wherein the control means select, at the start of the drying and dewrinkling process, a coefficient (k) equal to a predetermined constant, with the result that if the difference between the temperature (T) and the dew temperature (Tr) is smaller than the maximum thermal jump (ΔT) multiplied by said predetermined constant, they deduce that there is a lack of clothes in the inner space and stop the drying and dewrinkling process.

7. Cabinet according to claim 2, wherein the control means deduce the water load in the inner space depending on the variation of the temperature (T) measured in an initial phase of the drying and dewrinkling process.

8. Cabinet according to the preceding claim, wherein the control means establish a dewrinkling temperature (Td) depending on the water load in the inner space in the initial phase of the drying and dewrinkling process.

9. Cabinet according to claim 1, wherein the control means obtain the specific humidity (W) depending on the measured temperature (T) and humidity (H), determine the specific humidity in the period of constant intensity (W_{PIC}), and continue with the drying and dewrinkling process for as long as the condition that the specific humidity (W) obtained minus the initial specific humidity (W₀) is greater than a certain percentage (p) of the specific humidity in the period of constant intensity (W_{PIC}) minus said initial specific humidity (W₀) is fulfilled.

10. Cabinet according to the preceding claim, wherein the control means select said percentage (p) depending on the required degree of drying.

11. Cabinet according to claim 9, wherein the control means deduce that there are a lack of clothes in the inner space and stop the drying and dewrinkling process if, at the start of said process, the specific humidity (W) measured does not vary.

12. Cabinet according to claim 9, wherein the control means deduce the water load in the inner space depending on the variation in the temperature (T) measured in an initial phase of the drying and dewrinkling process.

13. Cabinet according to the preceding claim, wherein the control means establish a dewrinkling temperature (Td) depending on the water load in the inner space in the initial phase of the drying and dewrinkling process.
